(19) United States
(12) Patent Application Publication
(10) Pub. No.: US 2009/0158304 A1
(43) Pub. Date: Jun. 18, 2009

(54) SYSTEMS AND METHODS FOR DATA COLLECTION IN NETWORKS

(76) Inventor: Baofeng Jiang, Pleasanton, CA (US)

Correspondence Address: AT&T Legal Department - HFZ;ATTN. Patent Docketing, One AT&T Way, Room 2A-207, Bedminstor, NJ, 07921, US

(21) Appl. No.: 11/959,199

(22) Filed: Dec. 18, 2007

(51) Int. Cl. G06F 13/00

(52) U.S. Cl. 719/328

(57) ABSTRACT

Systems and methods are disclosed for collecting data from network elements. A disclosed example apparatus to facilitate the collection of data from a network element includes a first bridge to receive an application program interface (API) call requesting information for the network element, a database to store protocol information associated with the network element, and a second bridge to translate the API call in accordance with the protocol information and to communicate the translated API call to the network element is disclosed.

### FIELD OF THE DISCLOSURE

This disclosure relates generally to networks and, more particularly, to systems and methods for data collection in communication networks.

### BACKGROUND

Digital subscriber line (DSL) service providers collect many types of data from network elements such as network diagnostics, quality-of-service data, usage data, and/or other service data that may be useful. However, it can take a long time to collect data from each network element due, in part, to the quantity of data to be collected and the speed at which such collection can take place. In some example systems, it may take about 3 hours to collect 8 hours of historical data from an asynchronous DSL (ADSL) DSL access multiplexer (DSLAM) serving 500 customers and about 6 hours to collect 48 hours of historical data from a very high bit rate DSL (VDSL) DSLAM serving 192 customers.

### BRIEF DESCRIPTION OF THE DRAWINGS

FIG. 1 is a block diagram of an example system for collecting data within a network.

FIG. 2 is a more detailed block diagram of a portion of the example system of FIG. 1.

FIG. 3 is a flowchart representative of example machine readable instructions that may be executed to send an application program interface call request from an operations support system to a network element.

FIG. 4 is a flowchart representative of example machine readable instructions that may be executed to store, retrieve and send data with a network element.

FIG. 5 is a flowchart representative of example machine readable instructions that may be executed to send a response to the request from a network element to a requesting operations support system.

FIG. 6 is an illustration of an example logic tree structure organizing information in a data store.

FIG. 7 is a block diagram of an example computer that may execute the machine readable instructions of FIGS. 3, 4, and/or 5 to implement the example system of FIG. 1.

### DETAILED DESCRIPTION

Certain examples are shown in the above-identified figures and described in detail below. In describing these examples, like or identical reference numbers will be used to identify common or similar elements. Although the following discloses example systems, it should be noted that such systems are merely illustrative and should not be considered as limiting. For example, it is contemplated that any form of logic may be used to implement the systems or subsystems disclosed herein. Logic may include, for example, implementations that are made exclusively in dedicated hardware (e.g., circuits, transistors, logic gates, hard-coded processors, programmable array logic (PAL), application-specific integrated circuits (ASICs), etc.), exclusively in software, exclusively in firmware, or in any combination of hardware, firmware, and/or software. Accordingly, while the following describes example systems, the examples are not the only way to implement such systems.

As mentioned above, it can take a long time to collect data from network elements. One cause of the long collection times is the long time it takes a digital subscriber line access multiplexer (DSLAM) to respond to queries. DSLAM delay is often caused by the complexity of data collection interfaces that pass queries and/or data between different elements in the network. Data collection interfaces may vary among manufacturers and network element types, which results in many different types of queries passing through complicated interfaces to deliver requests and/or data.

When operation support system (OSS) applications desire status information about a network, they may need to send many different requests to the same network element or to many different elements that may use several application program interfaces (APIs) to receive the desired information. When a network element, such as a DSLAM, receives the request it retrieves the requested data from its registers or from a management information base (MIB) within the DSLAM, which is a time-consuming process. Mass data collection from network elements can substantially increase the load on the network. Service providers typically must balance the need for data collection with avoiding reductions in data transfer speeds that may adversely affect customers' service. In order to retrieve data from large numbers of network elements in a timely fashion, some service providers use a large number of servers which can be a costly investment in assets.

The systems and methods disclosed below are capable of collecting data from network elements more quickly than prior systems. In an illustrated example, an example OSS application 10a, 10b, operated, for example, by technical support personnel, sends a request in the form of an API call to an element management system (EMS) 12. The example EMS 12 discussed below includes an application server 16a, 16b, 16c which handles the API call and communicates with the desired network element 20a, 20b, 20c. In the illustrated example, the network element 20a, 20b, 20c independently stores data at regular intervals in a logic tree structure in a data store within the corresponding network element 20a, 20b, 20c. Any or all of this data can be retrieved upon receiving a request for such data. In the illustrated example, the data is returned to the EMS 12, formatted according to the request, and then forwarded to the OSS 10a, 10b by the application server 16a, 16b, 16c. The systems and methods of the illustrated example are both scalable and flexible. For example, servers, network elements, and data types may be added or subtracted to/from the illustrated system without any change in the interface from the perspective of the OSS 10a, 10b. Using a single API call, technical support personnel using the OSS 10a, 10b can retrieve any number of available data types from any number of network elements in any desired format.

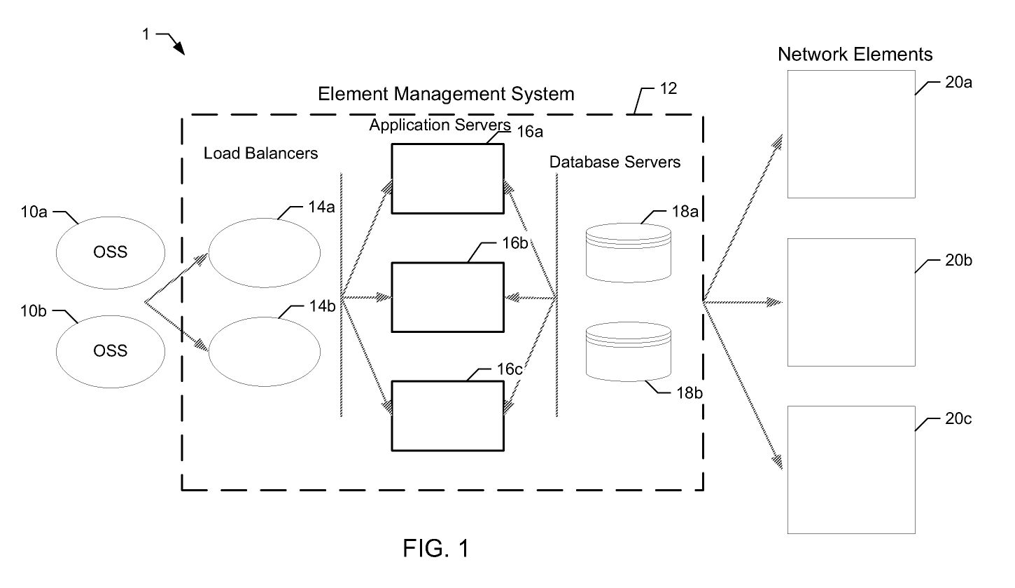

FIG. 1 is a block diagram of an example system 1 that facilitates data collection from multiple network elements 20a, 20b, and 20c. The example system 1 shown in FIG. 1 includes a plurality of operation support systems 10a and 10b, an EMS 12 and a plurality of network elements 20a-c. The EMS 12 includes, among other things, a plurality of load balancers 14a and 14b, a plurality of application servers 16a-c, and a plurality of database servers 18a, 18b.

In the illustrated example, technical support personnel at one of the OSS's 10a or 10b submit a request using a single API call to the EMS 12. One of the load balancers 14a or 14b receives the request and forwards it to one of the application servers 16a, 16b or 16c, depending on the relative current load state of each of the application servers 16a-c. Assume, for purposes of discussion, that the load balancer 14a receives the request and chooses the application server 16a to handle the request because server 16a currently has less of a load than application servers 16b and 16c. Assuming further that the request involves network element 20a, the application server 16a verifies the network element 20a. To verify the network element 20a, the application server 16a receives network topology data associated with the identified network element 20a from one or more of the database servers 18a and/or 18b and may confirm the existence of and/or address information for the network element 20a. The application server 16a communicates with the network element 20a based on the network topology data received from the database server(s) 18a and/or 18b.

The entire EMS 12 may be addressed with a single virtual internet protocol (IP) address. As a result, the example system 1 of FIG. 1 provides a simple interface between the OSS's 10a and 10b and the network elements 20a-c. Consequently, the OSS's 10a and 10b are relieved of the responsibility of storing the address information for all the network elements 20a-c and of the necessity to update the address information when the address of any of the network elements 20a-c changes.

The number of OSS application(s) 10a and 10b, load balancers 14a and 14b, application servers 16a-c, database servers 18a and 18b, and network elements 20a-c may be greater or fewer in number than shown in the example of FIG. 1, depending on specific implementation details, the number of subscribers and/or any other reason that may justify scaling the system 1.

The network elements 20a, 20b and/or 20c may be implemented by any type of network devices (e.g., DSLAMs) from which a service provider may desire to gather data. The desired data may be diagnostic, statistical, identification, and/or any other type that may be of use to the service provider.

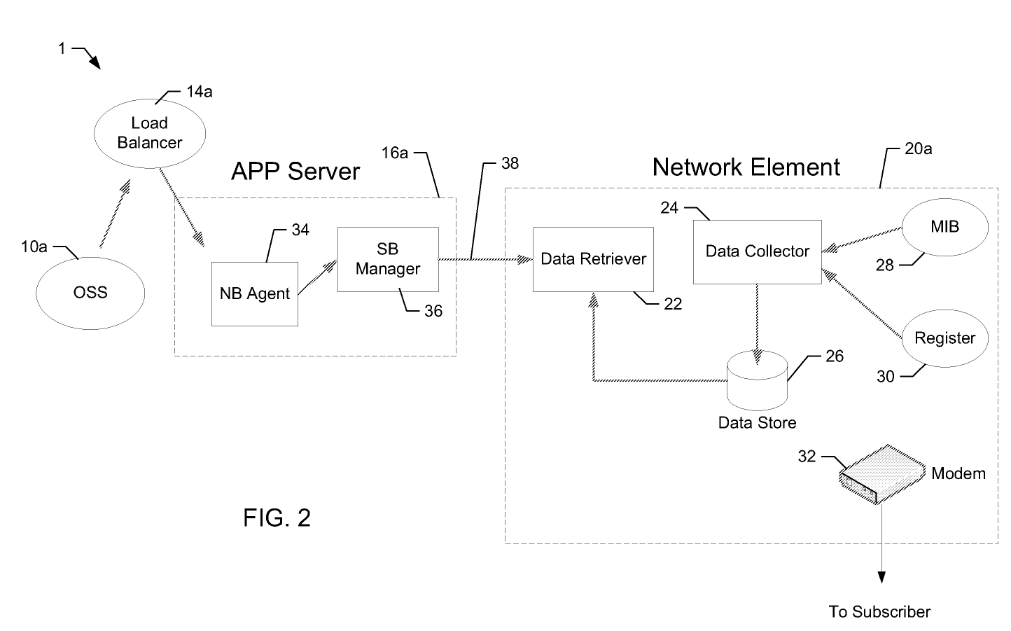

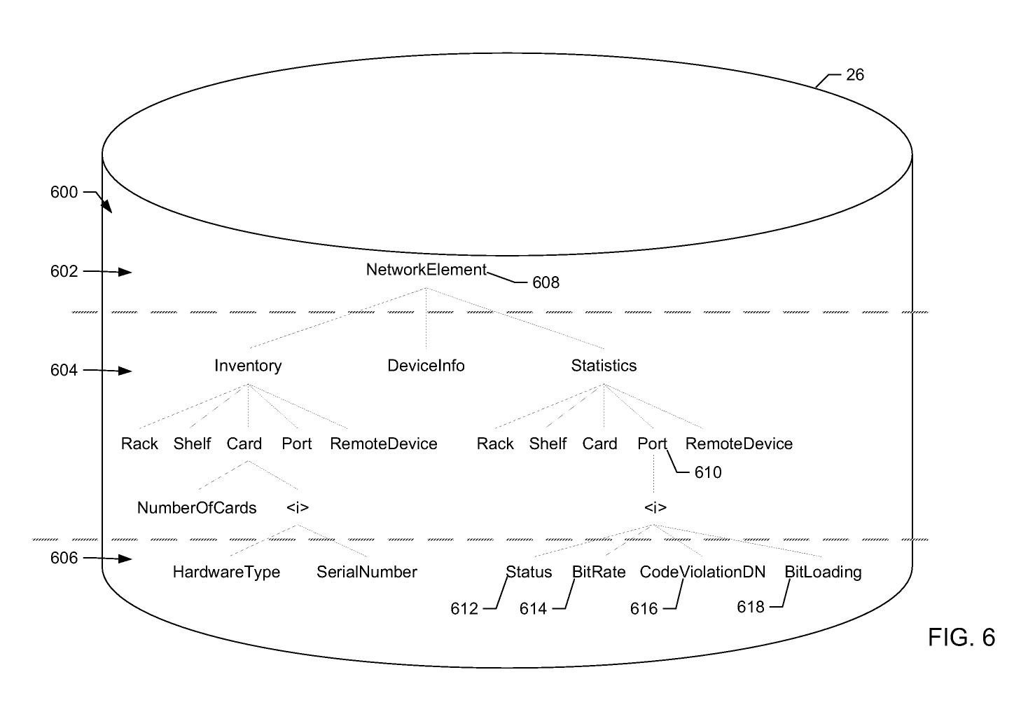

FIG. 2 is a more detailed block diagram of a portion of the example system 1 of FIG. 1. For simplification of explanation, FIG. 1 focuses on servicing one API call from the OSS 10a using the application server 16a to interact with the network element 20a of the example system 1 of FIG. 1. The example network element 20a includes a data retriever 22, a data collector 24, a data store 26, and at least one of a MIB 28 to store equipment configuration information, and/or a register 30, which contains data from a modem 32. Such data may include, for example, operational data, customer data, diagnostic data, statistical data, and/or identification data. The modem 32 communicates with a customer location in accordance with a service agreement. In the illustrated example, the data collector 24 reads information from the MIB 28 and/or the register 30 at predefined intervals (e.g., every 15 minutes) and populates the data store 26 with the collected information. In the illustrated example, information stored in the data store 26 is organized in an easily accessible fashion such as in the logic tree structure 600 described in connection with FIG. 6 below.

When a request is received from the OSS 10a, it is sent to a north bridge agent 34 running on the application server 16a. In the illustrated example, the request is in extensible markup language (XML) format. The request may be routed through the load balancer 14a or it may be communicated directly from the OSS 10a to the north bridge agent 34. The example north bridge agent 34 validates (i.e., verifies the existence of and/or address information for) the desired network element 20 based on data retrieved from the database server(s) 18a and/or 18b, and, if validated, sends the request to the south bridge manager 36 running on the application server 16a. The south bridge manager 36 translates the request from the north bridge agent 34 to the correct protocol used to communicate with the network element 20a. This protocol is determined from the data retrieved from the database server(s) 18a and/or 18b. Once the request is prepared, the south bridge manager 36 transmits the request to the data retriever 22 within the network element 20a via a network link 38.

The data retriever 22 receives the request from the south bridge manager 36 and fetches the desired information from the data store 26. The data retriever 22 of the illustrated example formats the information from the data store 26 according to the request, and then transmits the information to the south bridge manager 36 via the network link 38. The south bridge manager 36 receives the information from the network element 20a, translates the received information to the protocol used by the requesting OSS 10a, and then passes the formatted information to the north bridge agent 34. The north bridge agent 34 then relays the information to the requesting OSS 10a.

In addition to the functions in the above example, the north bridge agent 34 may perform other functions, such as user authentication (i.e., making sure user is authorized to request data), session control (i.e., the number of concurrent network elements that may be addressed if requesting data from multiple network elements), wait time control (length of time before a given request to a network element times out), or other procedures to facilitate proper operation.

The south bridge manager 36 may be responsible for data formatting as an alternative to formatting the data at the data retriever 22. Additionally or alternatively, the south bridge manager 36 may act to protect the network element 20a and/or the EMS 12 from attacks (e.g., viruses, intruder attacks, and/or data errors). For instance, the south bridge manager 36 may include a firewall or gateway to protect the network element 20a and or the EMS 12.

In the foregoing examples of FIGS. 1 and 2, the EMS 12 and the network elements 20a-c may be built and/or operated by different service providers, vendors and/or manufacturers, each of which may use different systems and/or methods to communicate between an OSS, an EMS and a network element. However, it may be desirable for an OSS to request information from a network element in a service provider/vendor/manufacturer-agnostic manner. Thus, the application server 16a (i.e., the north bridge agent 34 and/or the south bridge manager 36 within the application server 16a) of the illustrated example includes appropriate interfaces for the OSS 10a to communicate with any desired network element 20a, 20b and/or 20c using the same or substantially the same API call structure from the point-of-view of the OSS 10a.

The data collection and storage performed by the data collector 24 may be self-initiating, remotely controlled and/or manually controlled. Further, the data collection and/or storage may be done at any regular or irregular interval and/or continuously or substantially continuously. The data collector 24 may also collect and/or store data in response to a request sent to the data retriever 22. Various data associated with the network element 20a such as, for example, baud rate, bandwidth, and/or power usage, may be collected by the data collector 24.

The data retriever 22 may compress data prior to transmission to the south bridge manager 36 to reduce the load on the network link 38. In the illustrated example, data transmitted by the data retriever 22 in response to a request may be removed from the data store 26 in order to make room for the next set of data and/or it may be kept and/or archived by the data store 26.

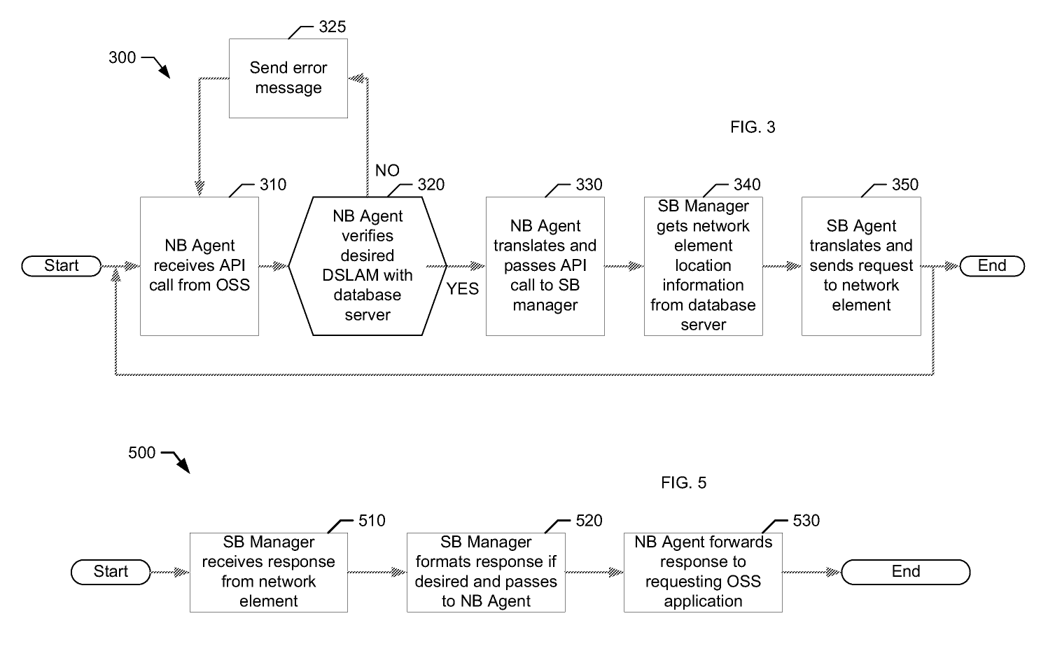

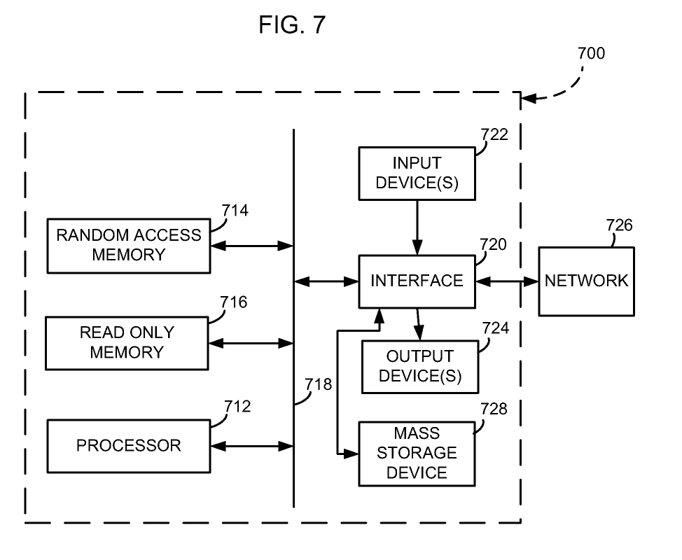

FIGS. 3-5 are flowcharts representative of example machine readable instructions that may be executed to implement the example EMS 12, the example network elements 20a-c of the system 1 of FIG. 1, the application servers 16a-c of the EMS 12, and the north bridge agent 34, the south bridge manager 36, the data retriever 22, the data collector 24, the data store 26, the MIB 28, and/or the register 30 of the system 1 of FIG. 2. The example machine readable instructions of FIGS. 3-5 may be executed by a processor, a controller, and/or any other suitable processing device. For example, the example machine readable instructions of FIGS. 3-5 may be embodied in coded instructions stored on a tangible medium such as a flash memory, or random access memory (RAM) associated with a processor (e.g., the processor 712 shown in the example processor platform 700 and discussed below in conjunction with FIG. 7). Alternatively, some or all of the example flowcharts of FIGS. 3-5 may be implemented using an ASIC, a programmable logic device (PLD), a field programmable logic device (FPLD), discrete logic, hardware, firmware, etc. In addition, some or all of the example flowcharts of FIGS. 3-5 may be implemented manually or as a combination of any of the foregoing techniques, for example, a combination of firmware, software, and/or hardware. Further, although the example machine readable instructions of FIGS. 3-5 are described with reference to the flowcharts of FIGS. 3-5, many other methods of implementing the example EMS 12, the network elements 20a-c, the application servers 16a-c, the north bridge agent 34, the south bridge manager 36, the data retriever 22, the data collector 24, the data store 26, the MIB 28, and/or the register 30 of the system 1 of FIG. 2 may be employed. For example, the order of execution of the blocks may be changed, and/or some of the blocks described may be changed, eliminated, sub-divided, and/or combined. Additionally, the example machine readable instructions of FIGS. 3-5 may be carried out sequentially and/or carried out in parallel by, for example, separate processing threads, processors, devices, circuits, etc.

FIG. 3 is a flowchart representative of example machine readable instructions 300 that may be executed to send an API call request from an OSS (e.g., from technical support personnel interacting with the OSS 10a and/or 10b shown in connection with FIG. 1) to a network element (e.g., the network element 20a, 20b and/or 20c shown in connection with FIG. 1).

The example machine readable instructions 300 of FIG. 3 may be executed to implement any of the example application server(s) 16a, 16b and/or 16c of FIGS. 1 and/or 2. However, for ease of reference, the following description will refer to application server 16a. In the illustrated example, the north bridge agent 34 of the application server 16a receives an API call request for network element information from an OSS 10a (block 310), which may have been routed through the load balancing circuit 14a. The north bridge agent 34 then verifies the requested network element 20a by querying one or more of the database servers 18a-b (block 320). If the network element 20a cannot be verified, an error message is sent to the OSS 10a and control returns to block 310 to await the next API call (block 325).

Assuming the network element 20a is verified (block 320), the API call request is translated by the north bridge agent 34, if necessary, and passed to the south bridge manager 36 (block 330). Next, the south bridge manager 36 of the application server 16a retrieves network topology information from one or more of the database server(s) 18a and/or 18b (block 340). The south bridge manager 36 then performs any needed translation and transmits the call via the network link 38 to the desired network element 20a (block 350). After the call is transmitted, control may return to block 310 to receive another API call.

Although certain elements are used in connection with the example method 300, it should be noted that the elements described may be replaced by similar or identical elements. For instance, the example OSS 10a and/or 10b may generate a call for information associated with the network element 20b, instead of the network element 20a.

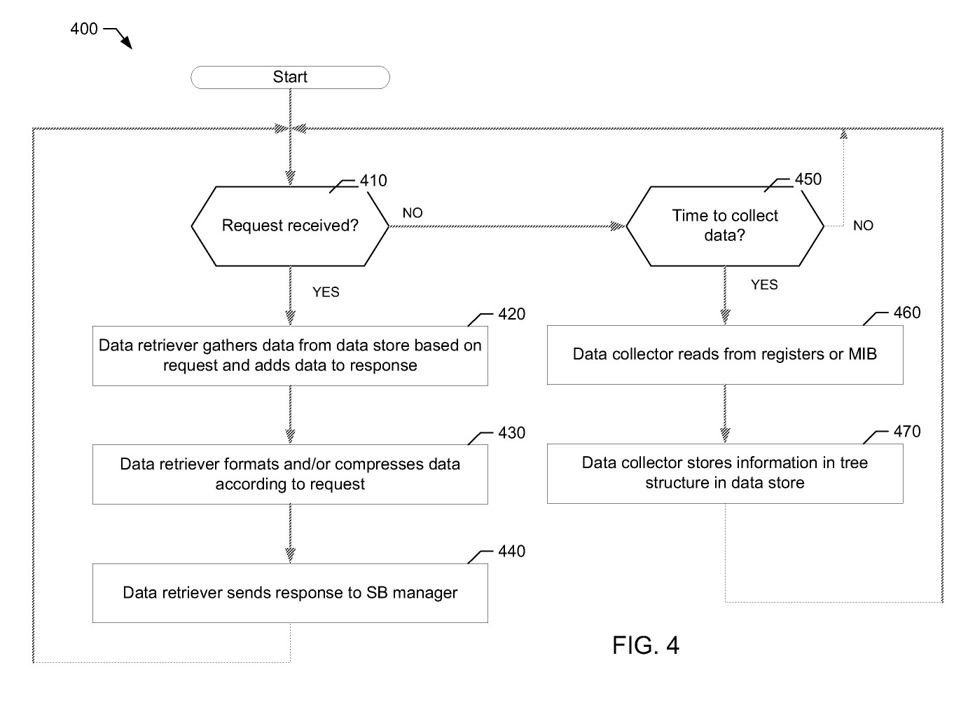

FIG. 4 is a flowchart representative of example machine readable instructions 400 that may be executed by a network element (e.g., the network element 20a, 20b and/or 20c shown in FIGS. 1 and 2) to store, retrieve and/or send data. For ease of discussion, the example of FIG. 4 will be described with reference to the network element 20a of FIG. 2. From the start of execution, the network element 20a periodically determines whether the data retriever 22 has received a request for data (block 410). If a request has been received (block 410), the data retriever 22 reads the request, gathers the requested data from the data store 26 and builds a response (block 420). The response data is formatted and/or compressed, if appropriate (block 430). The request is then sent to the south bridge manager 36 via the network link 38 (block 440). After the response is sent, control returns to block 410 to check if a request has been received.

If no request has been received (block 410), the data collector 24 of the network element 20a determines if there is a condition that requires the data collector 24 to retrieve data from the MIB 28 and/or registers 30 and store it in the data store 26 (block 450). If there is no condition that requires data collection and storage, control returns to block 410. If such a condition is present (e.g., a timer has expired), the data collector 24 reads data from the MIB 28 and/or the register 30 (block 460). The collected data is stored in the data store 26, for example, in a logic tree structure described below in connection with FIG. 6 (block 470). When data collection and storage are complete (block 460 and block 470), control returns to block 410.

FIG. 5 is a flowchart representative of example machine readable instructions 500 that may be executed to send a response to a request from a network element (e.g., the network element 20a, 20b or 20c shown in FIGS. 1 and 2) to a requesting user (e.g., the OSS 10a or 10b shown in FIGS. 1 and/or 2). For ease of reference, in the example of FIG. 5 the machine-readable instructions will be executed or performed on the application server 16a in response to a message received from network element 20a.

At the start of execution of the machine readable instructions 500, a response from the network element 20a is received at the south bridge manager 36 via the network link 38 (block 510). If desired and not already performed by the network element 20a, the south bridge manager 36 may format, reformat and/or decompress the response data to be usable by the requester (e.g., the OSS 10a). The south bridge manager 36 then passes the prepared response to the north bridge agent 34 (block 520). The north bridge agent 34 receives the response from the south bridge manager 36, translates the response, if necessary, and transmits the response to the OSS 10a that generated the corresponding request (block 530).

FIG. 6 is an illustration of an example logic tree structure 600 to organize the information stored in the data store 26 of any of the network elements 20a, 20b or 20c shown in FIG. 1 and/or FIG. 2. Data in the tree are populated by the data collector 24 and retrieved by the data retriever 22 as explained above. The example logic tree structure 600 is organized with a primary or root tree level 602, and one or more intermediate levels encompassing one or more branch levels 604. Any level including of only one data element is a leaf level 606. Branch levels 604 may have levels above, and/or below. For example, the branch level “Card” is a sublevel of the branch “Inventory” and also has a sub-branch “NumberofCards.” Leaf levels 606 include one data element, but may have multiple data points. For example, the leaf level “BitRate” may have a data point corresponding to every 15 minute interval for the most recent 24 hour period.

When retrieving data from the structure 600, one or more data elements may be retrieved based on the addressed level 602, 604, 606 of the structure 600. By addressing an element at the root level 602 or at an intermediate level 604, the addressed element and all elements branching from the addressed element are retrieved. For example, addressing the element NetworkElement 608 at the root level 602 will retrieve all data elements in the structure. As another example, addressing Port 610 at the intermediate level 604 will retrieve Port 610, Status 612, BitRate 614, CodeViolationDN 616, and BitLoading 618.

It should be noted that the logic tree structure and its corresponding levels may be flexible and/or expandable. For example, the branch level 604 “Inventory” is linked to several branches on a lower branch level 604. Branches stemming from a branch (e.g., “Inventory”) may be added or subtracted without changing the nature of the logic tree structure. A data element such as “HardwareType” at the leaf level 606 may be elevated to a new branch level 604 by adding an additional level or element below the data element (e.g., an element stemming from “HardwareType”). Different implementations may be used to improve read and write speeds for the data store 26.

Various data associated with a network element (e.g., the network element 20a shown in FIG. 2) such as, for example, baud rate, bandwidth, and/or power usage, may be collected by the data collector 24 of the network element 20a. Network elements may be implemented differently by different vendors or manufacturers, resulting in similar data being represented differently. For example, power consumption of a network element may be called “Power Usage” by a first vendor and called “PWR_CONS” by a second vendor. It is desirable for public data elements (e.g., data elements in the example data store 26 that are accessible by an API call from an OSS) to have standard names, which allows an API call from an OSS to have an identical structure when addressing network elements from different vendors or manufacturers. This relieves technical support personnel from the responsibility of searching for the correct commands to request data from multiple network elements.

The following example call may be used with the above described methods and/or apparatus getRealTimeData (network_element_id, parameter_list, data_format_control, data_intervals). This call includes the parameter network_element_id, which is used to identify the network element from which the OSS 10a is requesting data, the parameter parameter_list, which is used to identify the desired data within the data store 26 of the network element identified in network_element_id, the parameter data_format_control, which is used to format the desired data, and the parameter data_intervals, which is used to identify how much data is desired (e.g., the number of data points). If a user submits the call “getRealTimeData (DSLAM_A, “NetworkElement.*”, XML, 120),” the example system will return all data elements for the last 120 data collection intervals from DSLAM_A in XML format.

Another example call “getRealTimeData (DSLAM_A, “NetworkElement.Inventory.Card.*”, CSV, 120)” causes the example system to return all sub-branches and/or leaves of the Card sub-branch of the Inventory branch for the last 120 data collection intervals in CSV format. The API call may have other parameters such as user options to specify compression and/or other desirable functions. Further, each parameter may be given more than one argument.

FIG. 7 is a block diagram of an example processing system 700 that may execute the instructions represented by FIGS. 3, 4, and/or 5 to implement the example system of FIG. 1 and/or FIG. 2. The processing system 700 can be, for example, a server, a personal computer, a personal digital assistant (PDA), an Internet appliance, a digital versatile disk (DVD) player, a CD player, a digital video recorder, a personal video recorder, a set top box, or any other type of computing device.

A processor 712 is in communication with a main memory including a volatile memory 714 and a non-volatile memory 716 via a bus 718. The volatile memory 714 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 716 may be implemented by flash memory and/or any other desired type of memory device. Access to the main memory 714, 716 is typically controlled by a memory controller (not shown).

The processing system 700 also includes an interface circuit 720. The interface circuit 720 may be implemented by any type of interface standard, such as an Ethernet interface, a universal serial bus (USB), and/or a third generation input/output (3GIO) interface.

One or more input devices 722 are connected to the interface circuit 720. The input device(s) 722 permit a user to enter data and commands into the processor 712. The input device(s) can be implemented by, for example, a keyboard, a mouse, a touchscreen, a track-pad, a trackball, isopoint and/or a voice recognition system.

One or more output devices 724 are also connected to the interface circuit 720. The output devices 724 can be implemented, for example, by display devices (e.g., a liquid crystal display, a cathode ray tube display (CRT), a printer and/or speakers). The interface circuit 720, thus, typically includes a graphics driver card.

The interface circuit 720 also includes a communication device such as a modem or network interface card to facilitate exchange of data with external computers via a network 726 (e.g., an Ethernet connection, a digital subscriber line (DSL), a telephone line, coaxial cable, a cellular telephone system, etc.).

The processing system 700 also includes one or more mass storage devices 728 for storing software and data. Examples of such mass storage devices 728 include floppy disk drives, hard drive disks, compact disk drives and (DVD) drives. In the implementation of the processing system 700 as the network element 16a, the mass storage device may be combined with or integrated as a partition into the data store 26. The data store 26 may be implemented as any of the described examples of a mass storage device.

As an alternative to implementing the methods and/or apparatus described herein in a system such as the device of FIG. 7, the methods and/or apparatus described herein may alternatively be embedded in a structure such as processor and/or an ASIC.

At least some of the above described example methods and/or apparatus are implemented by one or more software and/or firmware programs running on a computer processor. However, dedicated hardware implementations including, but not limited to, application specific integrated circuits, programmable logic arrays and other hardware devices can likewise be constructed to implement some or all of the example methods and/or apparatus described herein, either in whole or in part. Furthermore, alternative software implementations including, but not limited to, distributed processing or component/object distributed processing, parallel processing, or virtual machine processing can also be constructed to implement the example methods and/or apparatus described herein.

It should also be noted that the example software and/or firmware implementations described herein are optionally stored on a tangible storage medium, such as: a magnetic medium (e.g., a magnetic disk or tape); a magneto-optical or optical medium such as an optical disk; or a solid state medium such as a memory card or other package that houses one or more read-only (non-volatile) memories, random access memories, or other re-writable (volatile) memories; or a signal containing computer instructions. A digital file attached to e-mail or other information archive or set of archives is considered a distribution medium equivalent to a tangible storage medium. Accordingly, the example software and/or firmware described herein can be stored on a tangible storage medium or distribution medium such as those described above or successor storage media.

Although this patent discloses example systems including software or firmware executed on hardware, it should be noted that such systems are merely illustrative and should not be considered as limiting. For example, it is contemplated that any or all of these hardware and software components could be embodied exclusively in hardware, exclusively in software, exclusively in firmware or in some combination of hardware, firmware and/or software. Accordingly, while the above specification described example systems, methods and articles of manufacture, persons of ordinary skill in the art will readily appreciate that the examples are not the only way to implement such systems, methods and articles of manufacture. Therefore, although certain example methods, apparatus and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. An apparatus to facilitate the collection of data from a network element, the apparatus comprising:
a first bridge to receive an application program interface (API) call requesting information for the network element;
a database to store protocol information associated with the network element; and
a second bridge to translate the API call in accordance with the protocol information and to communicate the translated API call to the network element.

2. An apparatus as defined in claim 1, further comprising a load balancer to communicate the API call to the first bridge or to a third bridge.

3. An apparatus as defined in claim 2, wherein the load balancer selects between the first bridge and the third bridge based on relative loads of the first bridge and the third bridge.

4. An apparatus as defined in claim 1, wherein the database stores network topology information.

5. An apparatus as defined in claim 1, wherein the first bridge further is to perform at least one of user authentication, wait time control or session control.

6. An apparatus as defined in claim 1, wherein the second bridge is to format the data collected from the network element based on a parameter of the API call.

7. An apparatus as defined in claim 1, wherein the first bridge communicates the data collected for the network element to an originator of the API call.

8. An apparatus as defined in claim 1, wherein the first bridge is further to receive a second API call associated with a second network element and the second bridge is further to translate the second API call into a format different from the translated API call associated with the first network element, the API call and the second API call having substantially the same systems.

9. A method to collect data from a network element, the method comprising:
receiving an application program interface (API) call requesting data associated with the network element;
translating the API call based on protocol information associated with the network element;
communicating the translated API call to the network element; and
storing the protocol information associated with the network element.

10. A method as defined in claim 9, further comprising communicating the API call to a first bridge or a second bridge.

11. A method as defined in claim 10, wherein the API call is communicated to the first bridge or the second bridge based on the relative loads of the first bridge and the second bridge.

12. A method as defined in claim 9, further comprising retrieving network topology information associated with the network element and communicating with the network element based on the retrieved network topology information.

13. A method as defined in claim 9, further comprising performing at least one of user authentication, wait time control or session control.

14. A method as defined in claim 9, further comprising formatting the data based on a parameter of the API call.

15. A method as defined in claim 9, further comprising communicating the data to the originator of the API call.

16. A method as defined in claim 9, further comprising receiving a second API call associated with a second network element and translating the second API call into a format different from the translated API call associated with the first network element, wherein the API call and the second API call have substantially the same systems.

17. An article of manufacture storing machine readable instructions which, when executed, cause a machine to:
receive an application program interface (API) call requesting data from a network element;
translate the API call based on protocol information associated with the network element;
communicate the API call to the network element; and
store the protocol information associated with the network element.

18. An article of manufacture as defined in claim 17, wherein the machine readable instructions further cause the machine to communicate the application program interface call to one of a first bridge or a second bridge.

19. An article of manufacture as defined in claim 18, wherein the machine readable instructions cause the machine to communicate the application program interface call from a load balancer to the first bridge or the second bridge based on the current status of the apparatus.

20. An article of manufacture as defined in claim 17, wherein the machine readable instructions further cause the machine to retrieve network topology information for the network element and communicate with the network element based on the retrieved network topology information.

21. An article of manufacture as defined in claim 17, wherein the machine readable instructions further cause the machine to perform at least one of user authentication, wait time control or session control.

22. An article of manufacture as defined in claim 17, wherein the machine readable instructions further cause the machine to format the data on based on a parameter of the API call.

23. An article of manufacture as defined in claim 17, wherein the machine readable instructions further cause the machine to communicate the data to the originator of the API call.

24. An article of manufacture as defined in claim 17, wherein the machine readable instructions further cause the machine to receive a second API call associated with a second network element and translate the second API call into a format different from the translated API call associated with the first network element, wherein the API call and the second API call have substantially the same systems.
